(19) United States
(12) Patent Application Publication
(10) Pub. No.: US 2015/0127365 A1
(43) Pub. Date: May 7, 2015

(54) HAND HYGIENE USE AND TRACKING IN THE CLINICAL SETTING VIA WEARABLE COMPUTERS

(71) Applicant: Sidra Medical and Research Center, Doha (QA)

(72) Inventors: Avez Ali RIZVI, Knoxville, TN (US); Saif Reza AHMED, Brooklyn, NY (US); Deepak KAURA, Doha (QA)

(21) Appl. No.: 14/530,291

(22) Filed: Oct. 31, 2014

Related U.S. Application Data
(60) Provisional application No. 61/899,140, filed on Nov. 1, 2013.

(51) Int. Cl. G06Q 50/22; G06T 19/00; G02B 27/01; G06K 9/00; G08B 21/24; G06Q 30/00

(52) U.S. Cl. CPC G06Q 50/22; G08B 21/245; G06Q 30/018; G02B 27/017; G06K 9/00355; G06T 19/006; G02B 2027/0178
USPC 705/2

(57) ABSTRACT

Processes and systems for monitoring hand hygiene events (e.g., hand washing or sanitizing) are provided. In one example, a process includes receiving data associated with the initiation and completion of a hand hygiene event. The data may include image data captured by a camera included with a wearable computer device (e.g., a head mounted device or augmented reality glasses). The process may further determine a location and/or time associated with the initiation and completion of the hand hygiene event and monitor compliance and technique. A process may further include detecting a location (e.g., via a proximity beacon) of a wearable computer device and triggering a notification to initiate a hand hygiene event. Additionally, data from hand hygiene events, including compliance data, can be used to motivate or incentivize individuals to increase their compliance with hand hygiene practices (e.g., through various gamification strategies).

### CROSS-REFERENCE TO RELATED APPLICATION

This application claims the benefit of priority to U.S. Provisional Ser. No. 61/899,140, filed on Nov. 1, 2013, entitled HAND HYGIENE USE AND TRACKING IN THE CLINICAL SETTING VIA WEARABLE COMPUTERS, which is hereby incorporated by reference in its entirety for all purposes.

### FIELD

This relates generally to the field of medicine and the reduction of hospital-acquired infections, and, in one example, to the use of wearable technology and the implementation of gamification in the hospital setting to increase hand hygiene compliance.

### BACKGROUND

Hospital-acquired infections (HAIs) account for billions of dollars of direct healthcare cost to U.S. hospitals annually. The costs range from a conservative $5.7 billion to as high as $31.5 billion (see, e.g., Department of Health and Human Services, The Direct Medical Costs of Healthcare-Associated Infections in U.S. Hospitals and the Benefits of Prevention, by R. D. Scott, II, CDC, March 2009; the contents of which are incorporated herein by reference in their entirety). In addition, implementation of simple and effective hand-washing/hygiene techniques can reduce the burden of HAIs significantly (see, e.g., World Health Organization, United Nations, WHO Guidelines on Hand Hygiene in Health Care: A Summary: First Global Patient Safety Challenge Clean Care Is Safer Care, WHO, July 2009; the contents of which are incorporated herein by reference in their entirety).

Unfortunately, healthcare worker adoption of hand hygiene use is a difficult problem to approach. Confirmation of hand hygiene compliance via tracking alone does little to confirm proper use of hand hygiene techniques. All of the current hand hygiene utilities promise both hardware and software approaches to track hygiene usage and report data without real solutions to reduce non-compliance or address proper hand hygiene techniques.

### BRIEF SUMMARY

According to one aspect of the present invention, a computer-implemented process for monitoring hand hygiene events (e.g., hand washing or sanitizing) is provided. In one example, a process includes receiving data associated with the initiation and completion of a hand hygiene event. The data may include image data captured by a camera included with a wearable computer device of the user (e.g., a head mounted device or augmented reality glasses). The process may further determine a location and/or time associated with the initiation and completion (e.g., the duration) of the hand hygiene event and monitor compliance with proper hand hygiene techniques.

According to another aspect of the present invention, a computer-implemented process for monitoring hand hygiene events includes detecting the location (e.g., via a proximity beacon) of a wearable computer device of a user. The process can access information for the user and the location relating to hand hygiene information, and cause a notification (e.g., a vibration, noise, or visual display) to be sent to the user device to remind or prompt the user to initiate a hand hygiene event. The process can further determine if the user complies with the hand hygiene event (e.g., based on detected hand hygiene events and the hand hygiene information associated with the detected proximity and the user's profile).

According to another aspect of the present invention, data from hand hygiene events, including compliance data, can be used to motivate or incentivize individuals to increase their compliance with hand hygiene practices. For example, various gamification strategies may be employed, whereby users accumulate points, rankings, badges, or the like. Additionally, such gamification points, rankings, badges, and the like may be redeemable for goods or services.

Additionally, systems, electronic devices, graphical user interfaces, and non-transitory computer-readable storage medium (the storage medium including programs and instructions for carrying out one or more of the processes described) for monitoring and tracking hand hygiene events and providing various user interfaces are described.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates an exemplary process for triggering a hand hygiene event based on location and a user profile.

FIG. 2 illustrates an exemplary process for triggering and monitoring a hand hygiene event process.

FIG. 3 illustrates an exemplary system and environment in which various embodiments of the invention may operate.

FIG. 4 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

This description relates generally to computer-implemented methods and systems configured to facilitate in the tracking and confirmation of hand hygiene use to prevent nosocomial HAIs using wearable technology and gamification strategies. In certain embodiments, these methods and systems are operated by a processor running on a computer which may be a server or a mobile device such as a wearable computer (e.g., smart glasses, augmented reality devices, or other wearable electronics including a camera).

Wearable computer devices (e.g., including a camera and display) provide a platform to track hand hygiene participation, address proper hand hygiene technique, and provide each user with a unique game-based profile. The natural display of wearable computer devices generally allows for viewing of “achievement timelines” and personal tracking of data. In addition, the display, tactile abilities, and sound production of most wearable computer devices allows for a multi-level notification approach to remind or trigger hand hygiene events.

One embodiment described herein comprises the ability of wearable computer devices to track not only “proximity” to a hand hygiene dispenser/sink, but also to confirm proper compliance by any number of healthcare professionals within different hospital settings. Compliance can be easily achieved and verified using camera technology included with wearable computers.

Further, the combination of intuitive and fun approaches that incentivize users (e.g., in a game-based or gamification environment) to participate in hand-hygiene could potentially aid in dramatically reducing nosocomial HAIs. Broadly, as used herein, “gamification” includes strategies that use techniques in game design in non-game contexts in order to motivate and incentivize individuals to perform more efficiently, use better skills, and maintain compliance of tasks. For example, gamification strategy can use a system of “points” to assign value to each triggered event. Points can be numeric values (symbolic or literal) weighted depending on context and importance. An example of an “event” in the present context is the use of proper hand-hygiene techniques prior to a patient encounter. Points can be used to determine a “rank,” which can be displayed using any number of ranking strategies that include, but are not limited to, badges, positions (both commonly used and unique), and any symbology (both unique and common) that associates the ranking of the individual user (e.g., stars, shields, flags, badges, trophies, names, and the like) with a standard or other users.

Accordingly, one aspect of the invention includes incentivizing individuals to participate in the goal of reducing nosocomial infections using wearable technology by combining gamification strategies. Gamification strategies may encourage each individual healthcare provider to track his or her own progress, unlock milestones, match up with other users, and participate in team play. Process software may allow for creating a specific profile tied to each user. The profile may further display relevant information in the form of ranking, points earned, scenario charts, competition information, and achievement milestones.

In one example, accrued gamification points can be used or redeemed for monetary value (e.g., in exchange for money and/or as credit to buy goods or services from hospital vending machines, food services, or the like). Further, the use of accrued gamification points can be used to purchase items within the hospital setting for hospital-specific locations such as: hospital cafeteria, gift shop, coffee shops, or any other location tied to the hospital's governance.

As described in greater detail below, a wearable computer device may be configured to detect (e.g., via a camera associated therewith) hand gestures as a trigger that a hand hygiene event has started and/or completed. As used herein, “hand gestures” or “gestures” relates to the action of using the user's hands in a particular action, motion, or shape to trigger an event or sequence of events as recognized via a wearable computer device's camera/video/video-streaming device or technology.

The term “client device” or sometimes “electronic device” or just “device” as used herein is a type of computer generally operated by a person. Non-limiting examples of client devices include: personal computers (PCs), workstations, laptops, tablet PCs including the iPad, cell phones with various operating systems (OS) including iOS phones made by Apple Inc., Android OS phones, Microsoft OS phones, BlackBerry phones, or generally any electronic device capable of running computer software and displaying information to a user. Certain types of client devices which are portable and easily carried by a person from one location to another may sometimes be referred to as “mobile devices.” Some non-limiting examples of mobile devices include: cell phones, smart phones, tablet computers, laptop computers, wearable computers such as watches, augmented reality glasses (e.g., Optical Head-Mounted Display (OHMD) devices such as Google Glass or the like), or other accessories incorporating any level of computing, and the like.

As used herein, the term “database” generally includes a digital collection of data or information stored on a data store such as a hard drive. Some aspects described herein use methods and processes to store, link, and modify information such as user profile information. A database may be stored on a remote server and accessed by a mobile device through a data network (e.g., WiFi) or alternatively in some embodiments the database may be stored on the mobile device or remote computer itself (i.e., local storage). A “data store” as used herein may contain or comprise a database (i.e., information and data from a database may be recorded into a medium on a data store).

In some embodiments, the processes described herein are in relation to tracking and ensuring compliance of hand hygiene with the incorporation of gamification strategies. These data include, but are not limited to, subcategorized employment information including full name, department of employment, position of employment, particular shifts of employment, and other inclusive data used to build specific employee profiles. Other data may include proximity information, gesture recognition, video of hand hygiene compliance, and time-stamping data in relation to tracking users in the hospital setting. In addition, data on gamification (e.g., points earned, ranking levels, and the like) may be included. The systems and process described herein may therefore allow streamlined tracking and verification on compliance with gamification techniques using wearable computing in the hospital setting.

One advantage of the systems and processes described herein includes reducing friction and reminding the user of the need for compliance. For example, friction includes the slight moment of hesitation by a user that often decides whether an action is started now, delayed, delayed forever, or if an all-together alternate course is taken. An exemplary system includes both “definitive” and “best-guess” entry mechanisms to identify an “entity” and trigger a work flow. For example, a work-flow would be initiated with an entity or a list of potential entities from which a single entity can be selected.

An “entity” can be anything that is the subject of a work-flow. An entity may be a patient treatment area or the patient, but could also be a vial of blood, a container of stool, a tissue slide from a biopsy, or any entity that requires hand hygiene protocol to be initiated.

“Definitive” entry points include those that can identify an entity (e.g., room, patient, resource, or the like) with a high degree of confidence. Definitive entry points would be trusted enough that an entire work-flow (e.g., a hand hygiene process) could be started based on such an entry point; in such cases, the onus would be on the user to escape-out or cancel the work-flow if, for some reason, the work-flow was triggered for an incorrect entity. For example, definitive entry point mechanisms include (but are not limited to) the following:
Barcode (e.g., barcodes can be printed on items such as a traditional wrist-band, an ID card, an identification sticker on clothing, a medical file, a tube, a sample, or the like)
Quick Response (QR) Code
Iris scan
Fingerprint
Handprint/footprint
Inbound Communication ID (e.g., Caller ID)
Multi-factor mechanism—combinations of other definitive entry point mechanisms that add further certainty to an identification, or combinations including best-guess entry point mechanisms that bring the threshold of likelihood high enough to be treated as a definitive entry point mechanism.

“Best-guess” entry points generally include mechanisms that can identify an entity with some degree of confidence or can at least reduce the population of potential entities to a small list from which selection can be made. It should be noted that as some of these technologies improve, they can eventually become “definitive” entry points and treated as such. It should also be noted that given the total population from which the entity is selected, and how many results are potentially returned, with few hits or one likely hit, a best-guess entry point can “cross-over” and be returned as a definitive entry point to reduce the friction of choice. For example, best-guess entry points include, but are not limited to, the following:
Optical character recognition of printed/displayed IDs
Voice recognition
Facial recognition
Location mapping
RF-ID signal (note that RF-ID is listed as “best-guess” instead of “definitive” since there may be more than a single RF-ID signal at a scan location from, for example, multiple patients)
Bluetooth including Bluetooth Low Energy 4.0 (BTLE 4.0)
Personal device signature detection (e.g., smartphone WiFi MAC Address)

Which mechanisms are classified as definitive or best-guess as well as associated cross-over thresholds can be configurable by system users (e.g., a system administrator or the like). Further, system users could also define combinations of such mechanisms that, in union, can be treated as a definitive entry point mechanism.

Central Repository

In one example, the system maintains a database for each entity with categorized party types and locations. For example, party types can include a surgeon, nurse, patient transporter, and so on. Specific locations can also be stored. The database can further be available to align hand hygiene compliance with specific party types and locations. For example, if a patient transporter encountered a patient in the emergency room, the system can automatically know to query the associated profile of the patient transporter in the appropriate patient transporter category database and detect the location based on the appropriate location database. The central repository would contain a map that joins artifacts with party types and party-types with specific parties. The central repository may also contain all previously defined gamification artifacts and associated information.

Session Browsing and Exploration

The system may allow exploration and browsing of the context via multiple mechanisms to ensure the right mechanism is available at the right time. For example:
Traditional mouse/trackpad and keyboard control
Voice
Hand and arm gestures
Body gestures, especially head gestures

The correct mechanism can be tailored for the particular setting, which can be an important feature. For example, a physician may be in a sterile environment unable to touch devices, so gesture and voice control would be preferred over traditional mouse or touchscreen type control.

Alternatively, a physician may wish to interact with the system while his or her hands are soiled, with blood for example. Providing these alternative mechanisms eases the ability to have these interactions under such adverse conditions. The physician may even be able to multitask (e.g., have a conversation or direct a program via voice controls while washing his or her hands).

The exemplary system may further include several native controls. Additionally, the system may be configurable by the user, administrator, and/or implementation engineers to enable specific actions based on specific triggering mechanisms.

Exemplary native controls may include:
Using hand gestures to initiate or confirm hand hygiene use
Voice recognition to initiate or confirm hand hygiene use
Playing, pausing, rewinding, forwarding, and slowing videos with hand gestures (for instructional videos)
Exiting out of view mode with hand gestures, head gestures, or voice commands
Initiating contact with other healthcare staff based on voice and hand gestures

These sessions could be customized for the party type or type of healthcare provider involved. In particular, certain gestures or commands may be necessary for specific categories that are not needed for other categories of users. For example, a patient transporter may need to use certain gestures or commands to indicate patient pick up or drop off, whereas this would be excluded for other party types.

Dashboards

According to another aspect, dashboards may be displayed on the wearable device with information from real-time sources and central repositories for specific information as it relates to hand hygiene use. For example, if there are patient precautions (contact, isolation, air borne, or the like), the system can notify the user of this status within a displayed dashboard. If there is specific information that is relevant to a specific hand hygiene use such as hand washing with hot water versus sanitizer (e.g., with certain bacterial infections, such as Clostridium difficile), this information can also be displayed and available on the dashboard. The information appearing could be summarized based on context and based on the party type or type of healthcare provider viewing the results.

In addition, gamification dashboards can also be available to track points earned, ranking, recent accomplishments, and the like, as they relate to the various gaming strategies. Accordingly, in such examples, a user can be incentivized and encouraged to engage in desired activities (e.g., hand washing) in real-time as part of the gamification strategies.

Tracking and Detection

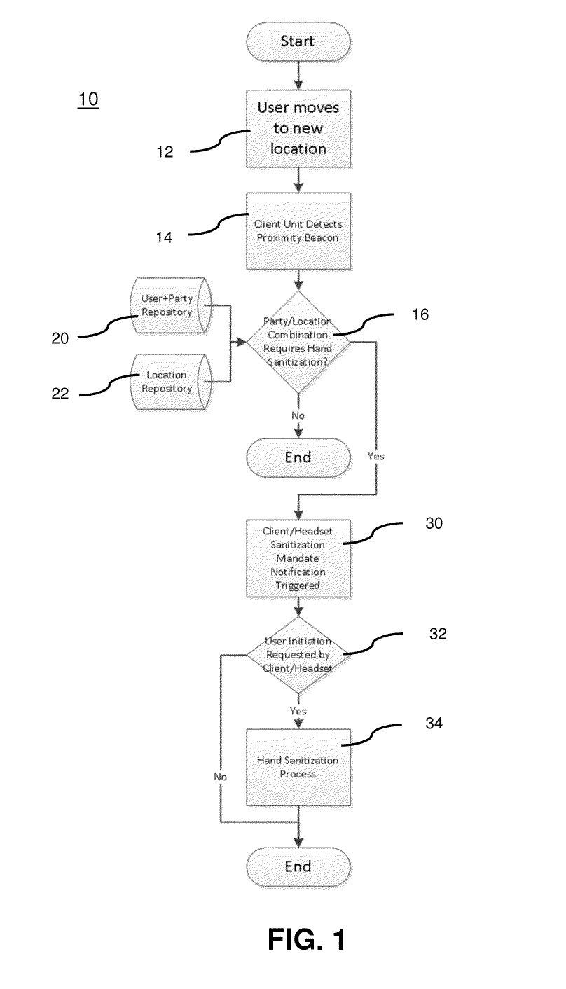

According to another aspect, an exemplary process and system allows for the detection of users as they interact with certain settings, which include patient encounter areas as previously described. While various detection methods can be used (e.g., with both “definitive” and “best guess” entry points as described above) an exemplary use with Bluetooth will be described and it will be understood that the example is applicable to other communication types (e.g., WiFi, infrared, near field sensors, and the like). For example, the detection process may use Bluetooth 4.0 Low Energy (BTLE) “beacons” that will be attached near patient settings with the actual location to be determined based on each particular setting. In one example, the wearable computing software will use the “electronic leash” application profile capabilities of the BTLE Proximity Profile (PXP) and Find Me Profile (FMP) to determine the location of each beacon in relation to the location of the wearable computer device as will be described relative to FIG. 1. A pre-determined location database associated with each beacon will then associate the user with the specific location and effectively track the user.

An exemplary process may include three primary features:
1. Proximity awareness
2. Initiation of hand hygiene event
3. Confirmation of hand hygiene event

The first feature, proximity awareness, can be addressed by tagging mechanisms comprising communication between the wearable computer and proximity to any patient setting. For example, patient settings may include, but are not limited to, clinical patient rooms, bays, or suites both within the hospital, outpatient/ambulatory setting, and any other setting or area where compliance is desired. In one example, a tagging mechanism may utilize any number of “Best-guess” entry point mechanisms that may include, but are not limited to, WiFi MAC Address, Bluetooth, QR Codes, and/or RFIDs. Threshold proximity triggers may execute notifications to a user's wearable computer (e.g., glasses or augmented reality devices) to engage in hand hygiene as further illustrated in FIG. 1.

In particular, and with reference to the exemplary process illustrated by FIG. 1, as a user moves through a hospital environment and into a new location at 12, the system may detect the user at 14. For example, the wearable computer device may detect a proximity beacon associated with the wearable device (or vice versa, e.g., a device associated with the location detecting the wearable computer device) and the system may determine the location of the user's wearable computer device and associate it with a particular location.

The system may further access or receive data associated with the user from a database 20. The information associated with the user may include the user's party type, employment history, hygiene history, locational history, and so on. The system may further access or receive data associated with the location from a database 22. The data associated with a location can include the type of location, hygiene levels desired or required for the location, history of events in the particular location, other users in the location, and so on.

The exemplary process may determine if a hygiene act should be initiated at 16, which may include a determination if any act needs to be carried out, or if one of a set of one or more acts needs to be carried out. For example, the hygiene act may be for the user to wash his or her hands; however, in other examples, the act may be for the user to use a particular hand sanitizer. The act to be carried out may vary based on the party type, such as the user's role (e.g., varying for nurse, surgeon, patient transporter, or the like), time and location of last hand hygiene event, and so on.

The second feature, initiation of a hand hygiene event, and the third feature, confirmation of the hand hygiene event, can be detected using the wearable computer's photo and/or video technology via hand gestures. For instance, hand gesture detection algorithms can be utilized to trigger the initiation of hand hygiene and the confirmation of hand hygiene completion based on specific hand gestures. The time between initiation and confirmation (or completion) of a hand hygiene process and the video information can be recorded through database logging and online file storage web services as another metric to quantify and analyze. In other examples, the initiation and/or completion of a hand hygiene event can be triggered via voice/sound, touch, or other input means by the user.

The process is highlighted in the second portion of FIG. 1, which may be initiated after it is determined at 16 that a hand hygiene action is desired. For example, the user's device can cause a notification that a hand hygiene action is to be carried out at 30. The notification can include a visual cue, vibration, audible cue, combinations thereof, or other notification or alert to the user. The notification can be generated by the user's wearable computer or another device (e.g., a device at the location of the user).

In one example, the user can then initiate a hand hygiene process at 32, and carry out the process at 34. The user can initiate the hygiene process through a hand gesture, voice command, manual input (e.g., via a touchscreen, button, or the like). A hand gesture might include a predefined motion or signal, but may also include a hand-scrubbing motion as the user begins to wash his or her hands. During the hand hygiene process the user's wearable computer may capture image data (e.g., one or more images or video) of the process. The image data can be stored locally or remotely for later viewing or verification, as well as for evaluating technique. The process may then end by a hand gesture (e.g., a hand signal or motion, or the ceasing of a hand-washing motion), at which time information relating to the time, duration, location, etc., can be stored locally and/or remotely for later use.

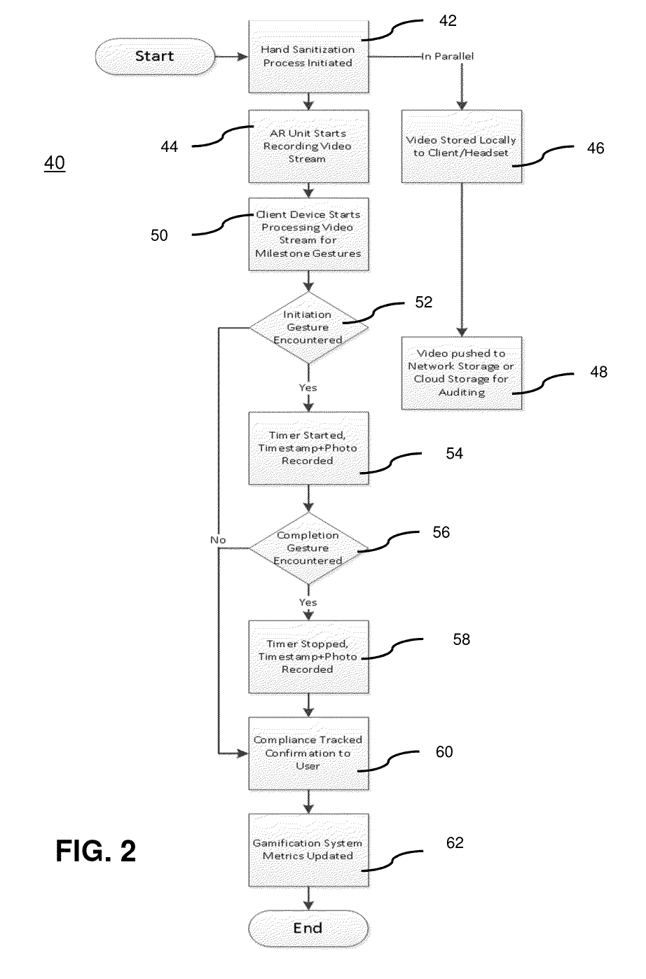

FIG. 2 illustrates another aspect of the invention, including an exemplary process 40 for execution by a wearable computer device. The exemplary process includes storing image data and compliance data, both of which can be output to a gamification system (as described herein) and/or compliance system. The exemplary process begins at 42, where a hand sanitization process is initiated. For instance, based on location data, the process can begin execution on the wearable computer device. The user's wearable computer device can record data at 44, and in parallel (or serially, later in time) can store the image data at 46 and push the image data to a remote storage at 48 (e.g., associated network or cloud storage).

The wearable computer device can process the recording image data for milestone gestures at 50 (e.g., gestures indicating that a hand hygiene process has been initiated). Upon encountering or recognizing a gesture indicating a hand hygiene process at 52, the process can timestamp the location in the video/image or start a timer at 54. Similarly, when a completion gesture is detected at 56, the process can timestamp the location in the video/image or stop the timer at 58, thereby providing a time of the start and finish of the hand hygiene process, as well as video or image data associated therewith.

In some examples, compliance with a standard or expectation of the hand hygiene process can then be communicated to the user (e.g., through the wearable computer device at 60). The compliance confirmation can be communicated shortly after completion of the process or later in time. Further, the metrics of a hand hygiene process, as well as a set of hygiene processes by a user, can be communicated to a gamification module or system as described herein. Further, the compliance confirmation information and other metrics can be communicated to the network or cloud storage at 48 with the image data.

Exemplary Architecture and Operating Environment

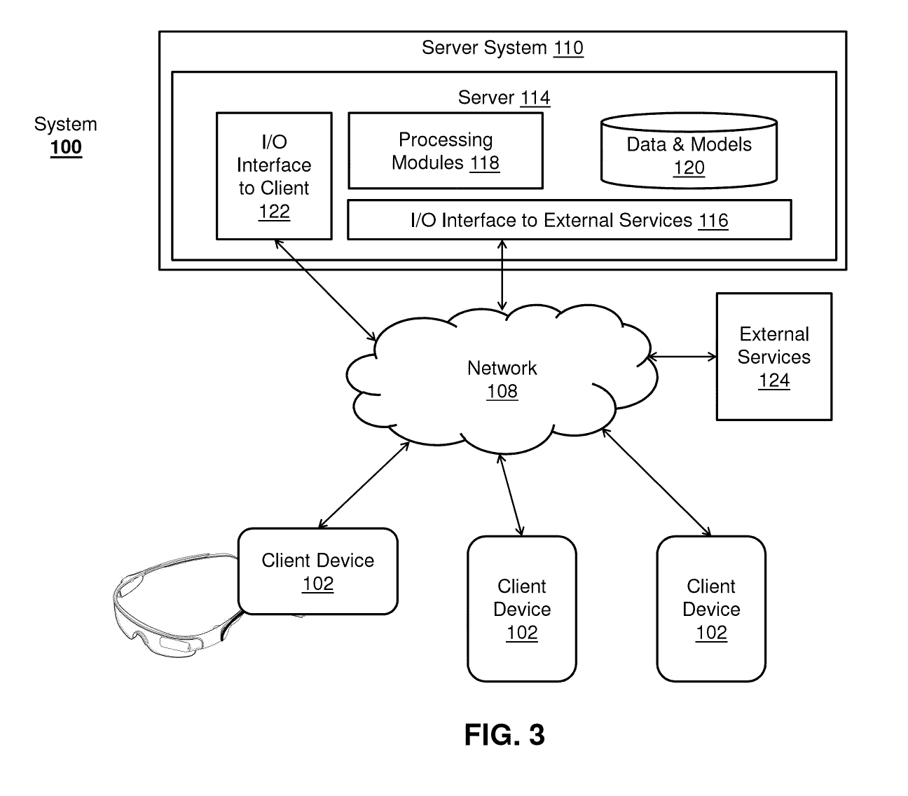

FIG. 3 illustrates an exemplary environment and system in which certain aspects and examples of the systems and processes described herein may operate. As shown in FIG. 3, in some examples, the system can be implemented according to a client-server model. The system can include a client-side portion executed on a user device 102 and a server-side portion executed on a server system 110. User device 102 can include any electronic device, such as a desktop computer, laptop computer, tablet computer, PDA, mobile phone (e.g., smartphone), wearable electronic device (e.g., digital glasses, wristband, or wristwatch), or the like. In one example, a user device 102 includes wearable electronic devices with at least an image detector or camera device for capturing images or video of hand hygiene events (e.g., initiation and completion of washing) and a display (e.g., for displaying notifications, a dashboard, and so on). For instance, user device 102 may include augmented reality glasses, head mounted wearable devices, and so on.

User device 102 can communicate with server system 110 through one or more networks 108, which can include the Internet, an intranet, or any other wired or wireless public or private network. The client-side portion of the exemplary system on user device 102 can provide client-side functionalities, such as user-facing input and output processing and communications with server system 110. Server system 110 can provide server-side functionalities for any number of clients residing on a respective user device 102. Further, server system 110 can include one or more hygiene servers 114 that can include a client-facing I/O interface 122, one or more processing modules 118, data and model storage 120, and an I/O interface to external services 116. The client-facing I/O interface 122 can facilitate the client-facing input and output processing for hygiene servers 114. The one or more processing modules 118 can include various proximity processes, hand hygiene triggering and monitoring processes, and gamifications processes as described herein. In some examples, hygiene server 114 can communicate with external services 124, such as user profile databases, streaming media services, and the like, through network(s) 108 for task completion or information acquisition. The I/O interface to external services 116 can facilitate such communications.

Server system 110 can be implemented on one or more standalone data processing devices or a distributed network of computers. In some examples, server system 110 can employ various virtual devices and/or services of third-party service providers (e.g., third-party cloud service providers) to provide the underlying computing resources and/or infrastructure resources of server system 110.

Although the functionality of the hygiene server 114 is shown in FIG. 1 as including both a client-side portion and a server-side portion, in some examples, certain functions described herein (e.g., with respect to user interface features and graphical elements) can be implemented as a standalone application installed on a user device. In addition, the division of functionalities between the client and server portions of the system can vary in different examples. For instance, in some examples, the client executed on user device 102 can be a thin client that provides only user-facing input and output processing functions, and delegates all other functionalities of the system to a backend server.

It should be noted that server system 110 and user devices 102 may further include any one of various types of computer devices, having, e.g., a processing unit, a memory (which may include logic or software for carrying out some or all of the functions described herein), and a communication interface, as well as other conventional computer components (e.g., input device, such as a keyboard/touchscreen, and output device, such as display). Further, one or both of server system 110 and user devices 102 generally includes logic (e.g., http web server logic) or is programmed to format data, accessed from local or remote databases or other sources of data and content. To this end, server system 110 may utilize various web data interface techniques such as Common Gateway Interface (CGI) protocol and associated applications (or “scripts”), Java® “servlets,” i.e., Java® applications running on server system 110, or the like to present information and receive input from user devices 102. Server system 110, although described herein in the singular, may actually comprise plural computers, devices, databases, associated backend devices, and the like, communicating (wired and/or wireless) and cooperating to perform some or all of the functions described herein. Server system 110 may further include or communicate with account servers (e.g., email servers), mobile servers, media servers, and the like.

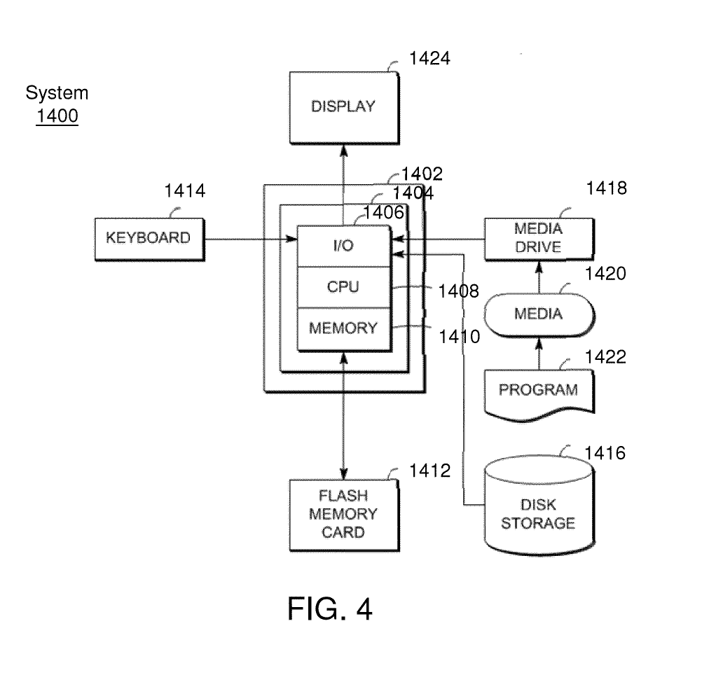

It should further be noted that although the exemplary methods and systems described herein describe the use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server system 110 (and other servers and services described herein) generally include such art recognized components as are ordinarily found in server systems, including, but not limited to, processors, RAM, ROM, clocks, hardware drivers, associated storage, and the like (see, e.g., FIG. 4, discussed below). Further, the described functions and logic may be included in software, hardware, firmware, or any combination thereof.

FIG. 4 depicts an exemplary computing system 1400 configured to perform any one of the above-described processes, including the various notification and compliance detection processes described above. In this context, computing system 1400 may include, for example, a processor, memory, storage, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 4 depicts computing system 1400 with a number of components that may be used to perform the above-described processes. The main system 1402 includes a motherboard 1404 having an input/output (“I/O”) section 1406, one or more central processing units (CPU) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, or Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

1. A computer-implemented method for monitoring hand hygiene events, the method comprising:
at an electronic device having at least one processor and memory:
receiving data associated with the initiation of a hand hygiene event;
receiving data associated with the completion of the hand hygiene event;
receiving image data associated with the hand hygiene event;
determining a time associated with the initiation and completion of the hand hygiene event; and
determining compliance of the hand hygiene event.

2. The method of claim 1, wherein the image data is captured by a wearable computer device comprising an image detector.

3. The method of claim 2, wherein the wearable computer device comprises augmented reality glasses.

4. The method of claim 2, wherein the wearable computer device comprises a head mounted computer device.

5. The method of claim 1, further comprising detecting a hand gesture associated with the initiation of the hand hygiene event.

6. The method of claim 1, wherein one or both of the initiation of a hand hygiene event and the completion of a hand hygiene event is triggered by voice recognition.

7. The method of claim 1, further comprising receiving video data associated with at least a portion of the hand hygiene event.

8. The method of claim 1, further comprising sending compliance information data to a gamification module.

9. The method of claim 8, wherein the gamification module stores one or more of points earned, rankings, and achievements for a user.

10. The method of claim 8, wherein the gamification module sends data to a user device for displaying one or more of points earned, rankings, and achievements for a user.

11. The method of claim 1, further comprising storing the image data associated with the hand hygiene event.

12. The method of claim 1, further comprising detecting a location of the hand hygiene event.

13. A computer-implemented method for monitoring hand hygiene events, the method comprising:
at an electronic device having at least one processor and memory:
detecting a location of a user of a wearable computer device;
associating the detected location with information relating to hand hygiene information;
triggering a notification on the wearable computer device to initiate a hand hygiene event based on the detected location and hand hygiene information; and
determining if the hand hygiene event was performed.

14. The method of claim 13, wherein the location is detected by detecting a proximity beacon relative to the wearable computer device.

15. The method of claim 13, wherein determining if the hand hygiene event was performed comprises detecting the initiation of a hand hygiene event.

16. The method of claim 13, wherein determining if the hand hygiene event was performed comprises:
detecting data associated with the initiation of a hand hygiene event;
detecting data associated with the completion of a hand hygiene event; and
determining a time associated with the initiation and completion of the hand hygiene event.

17. The method of claim 13, wherein the notification comprises at least one of a vibration, audible, or visual notification.

18. A non-transitory computer-readable storage medium comprising computer-executable instructions for:
receiving data associated with the initiation of a hand hygiene event;
receiving data associated with the completion of the hand hygiene event;
receiving image data associated with the hand hygiene event;
determining a time associated with the initiation and completion of the hand hygiene event; and
determining compliance of the hand hygiene event.

19. The non-transitory computer-readable storage medium of claim 18, wherein the image data is captured by a wearable computer device comprising an image detector.

20. The non-transitory computer-readable storage medium of claim 19, wherein the wearable computer device comprises augmented reality glasses.

21. The non-transitory computer-readable storage medium of claim 19, wherein the wearable computer device comprises a head mounted computer device.

22. The non-transitory computer-readable storage medium of claim 18, further comprising detecting a hand gesture associated with the initiation of the hand hygiene event.

23. A system comprising:
one or more processors;
memory; and
one or more programs, wherein the one or more programs are stored in the memory and configured to be executed by the one or more processors, the one or more programs including instructions for:
receiving data associated with the initiation of a hand hygiene event;
receiving data associated with the completion of the hand hygiene event;
receiving image data associated with the hand hygiene event;
determining a time associated with the initiation and completion of the hand hygiene event; and
determining compliance of the hand hygiene event.

24. The system of claim 23, wherein the image data is captured by a wearable computer device comprising an image detector.

25. The system of claim 24, wherein the wearable computer device comprises augmented reality glasses.

26. The system of claim 24, wherein the wearable computer device comprises a head mounted computer device.

27. The system of claim 23, further comprising detecting a hand gesture associated with the initiation of the hand hygiene event.
